(19) United States
(12) Patent Application Publication
(10) Pub. No.: US 2025/0360961 A1
(43) Pub. Date: Nov. 27, 2025

(54) Device and Method for Producing a Steering Sensation in a Steering System, Vehicle Comprising the Device

(71) Applicant: Robert Bosch GmbH, Stuttgart (DE)

(72) Inventor: Joerg Strecker, Schwaebisch Gmeund - Grossdein (DE)

(21) Appl. No.: 18/872,706

(22) PCT Filed: Jun. 6, 2023
(86) PCT No.: PCT/EP2023/065052

§ 371 Date: Dec. 6, 2024

(30) Foreign Application Priority Data
Jun. 8, 2022 (DE) 10 2022 205 785.6

(51) Int. Cl. B62D 5/04

(52) U.S. Cl. CPC B62D 5/046; B62D 5/0481

(57) ABSTRACT

In a method for producing a steering sensation in a steering system, which includes a motor and a torsion bar which are connected to each other via a gearing, a torque of the motor and a torsion bar torque at the torsion bar are determined, a stepped-up motor torque is determined depending on the motor torque and on a transmission ratio and efficiency of the gearing, a friction torque is determined depending on a difference between the stepped-up motor torque and the torsion bar torque, a desired friction torque is determined depending on the friction torque, a desired motor torque is determined depending on the desired friction torque and the motor torque, and the motor is activated to produce the desired motor torque.

### PRIOR ART

The invention relates to a device and method for producing a steering sensation in a steering system and a vehicle comprising said device.

Creating a pleasant and precise steering sensation requires a certain amount of friction. The steering system may comprise a steering wheel or other steering control element. Of particular importance is an area in which no movement of this control element is yet present, i.e. the area in which the driver begins to move the control element.

### DISCLOSURE OF THE INVENTION

A pleasant steering sensation is improved by the method and device according to the independent claims by producing a feeling of friction. The overall steering sensation is achieved, for example, by producing the sensation of friction, a sensation of a return force, and dampening.

The method for producing a steering sensation in a steering system, which comprises a motor and a control element, in particular a torsion bar, which are connected to each other via a gearing, wherein a torque of the motor and a torque at the control element, in particular a torsion bar, are determined at the torsion bar, wherein either a stepped-up motor torque is determined depending on the motor torque and on a transmission ratio and efficiency of the gearing, wherein a friction torque is determined depending on a difference between the stepped-up motor torque and the torque at the control element, in particular a torsion bar, or wherein a stepped-up motor torque is determined depending on the torque at the control element and on a transmission ratio and efficiency of the gearing, wherein a friction torque is determined depending on a difference between the motor torque and the stepped-up torque at the control element, and wherein a desired friction torque is determined depending on the friction torque, wherein a desired motor torque is determined depending on the desired friction torque, and wherein the motor is activated to produce the desired motor torque. With these two torques and the addition of the efficiency of the motor and gearing, system friction, i.e. the friction between motor torque and torque at the operating element, can be calculated at any given time. First, the actual system friction is determined, e.g., by adding the motor torque and the torque at the control element accordingly, wherein the motor torque is first stepped up to the same level as the torque at the control element, and the efficiency of the motor and gearing are taken into consideration. This means, for example, motor torque*=motor torque×transmission ratio×efficiency of friction torque=motor torque*−torsion bar torque. Analogously, the reference point for the difference determination can also be at the motor torque level, i.e. the torsion bar torque is converted with the transmission ratio. The motor torque is then corrected with the efficiency.

The desired friction torque is preferably determined depending on a predetermined factor at which the friction torque is changed. By continuously calculating the friction with the factor of friction, the active friction may also correspond to a multiple of the mechanical friction. This provides a great degree of freedom for producing the steering sensation.

Preferably, a sign for the factor is determined depending on an asymmetry with respect to a reference value for the friction torque. Based on the sign, the friction acts in the desired direction of movement. This serves to compensate for asymmetric effects.

The desired friction torque is preferably limited to a maximum value.

The maximum value is preferably determined depending on a vehicle speed.

Preferably, it is envisaged that a shift is made to the maximum value if a particular steering speed is exceeded.

The desired friction torque is preferably filtered.

The desired friction torque is preferably filtered with a low pass filter.

A device for producing a steering sensation in a steering system comprising a motor and a control element, particularly a torsion bar which are connected to each other via a gearing, comprises a computing device configured to perform the method depending on a sensed motor torque and a sensed torque at the control element, particularly a torsion bar torque.

The device preferably comprises a torque sensor, in particular a torsion bar torque sensor, configured to sense the torque, in particular the torsion bar torque.

A vehicle comprising a steering system with the device has corresponding advantages.

Further advantageous embodiments will become apparent from the following description and the drawing. The drawings show:

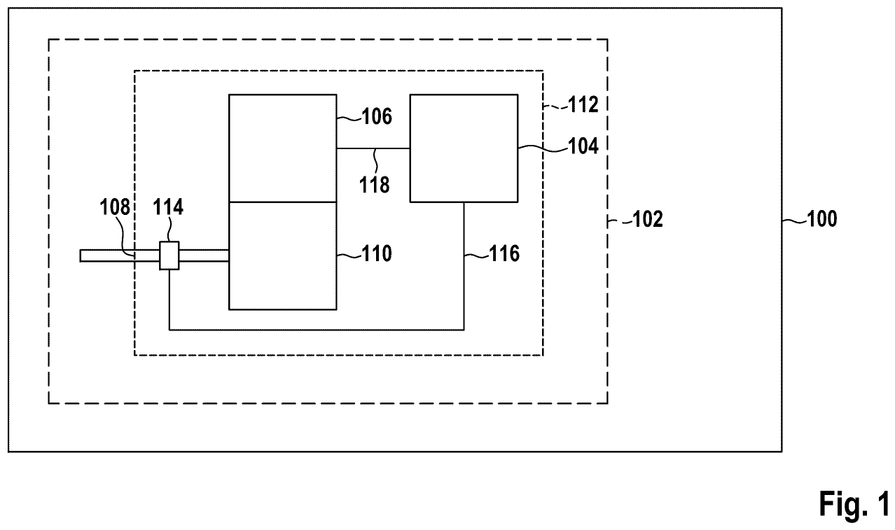

FIG. 1 shows a schematic illustration of a vehicle with a steering system,

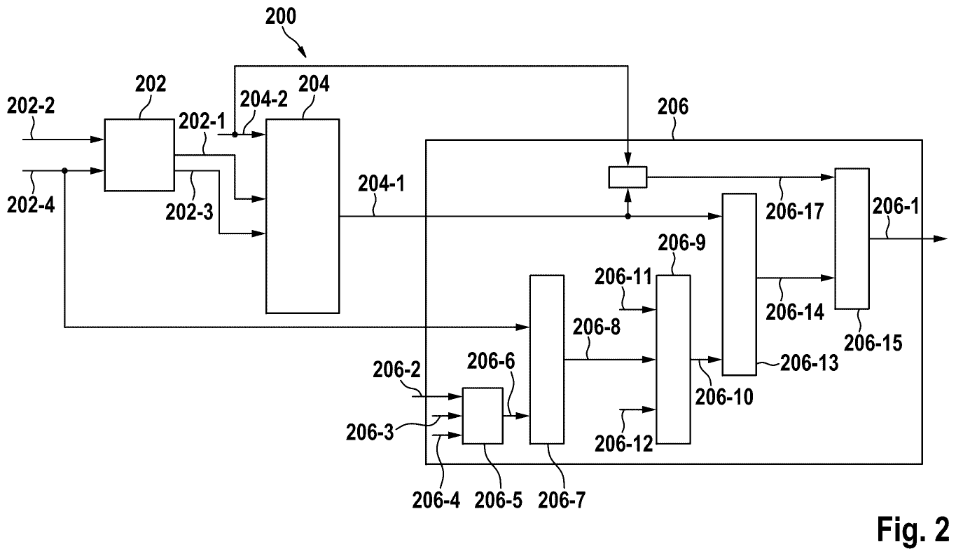

FIG. 2 shows a portion of an architecture of a controller for the steering system,

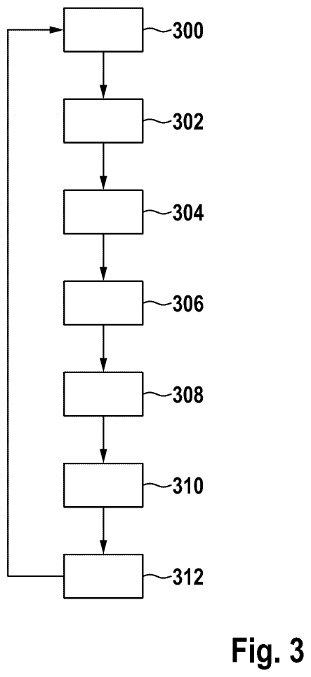

FIG. 3 shows a flowchart with steps in a method for producing a steering sensation.

A vehicle 100 is shown schematically in FIG. 1. The vehicle 100 comprises a steering system 102 and a computing device 104.

The steering system 102 comprises a motor 106 and a torsion bar 108 connected to each other via a gearing 110.

The vehicle 100 comprises a device 112 for producing a steering sensation in the steering system 102. The device 112 comprises the computing device 104, the motor 106, the gearing 110, and a torsion bar torque sensor 114 configured to sense a torsion bar torque. The torsion bar torque sensor 114 is configured to communicate the torsion bar torque to the computing device 104 via a signal line 116.

The computing device 104 is configured to control the steering system 102. The computing device 104 is configured to activate the motor 106 via an activation line 118 to generate a motor torque determined by the computing device 104.

A portion of an architecture 200 of a controller, with which the computing device 104 controls the steering system 102, is shown in FIG. 2. The torques mentioned below are torques in Nm in the example.

The architecture 200 provides a function 202 for determining a maximum torque 202-1 depending on a vehicle speed 202-2 and a scale factor 202-3 depending on a torsion bar torque 202-4.

The architecture 200 provides a function 204 for determining a speed-corrected maximum torque 204-1 depending on the maximum torque 202-1, the scale factor 202-3, and depending on a steering speed 204-2. The steering speed 204-2 is the speed in rad/s, at which the steering system 102 or a driver steers.

The architecture 200 provides a function 206 for determining a desired motor torque 206-1 depending on a motor torque 206-2, the speed-corrected maximum torque 204-1, and the torsion bar torque 202-4.

In the example, the desired motor torque 206-1 is determined depending on a parameter 206-3, which indicates by its sign whether the engine 106 is generating a motor torque that assists the driver or acts against the driver. For example, when steering to the left, a negative sign is provided when the motor torque 206-2 acts against the driver and a positive sign when the motor torque 206-2 assists the driver. For example, when steering to the right, a positive sign is provided when the motor torque 206-2 acts against the driver and a negative sign when the motor torque 206-2 assists the driver.

In the example, the desired motor torque 206-1 is determined depending on a parameter 206-4 that represents a transmission ratio and an efficiency of the gearing 110.

In the example, a sub-function 206-5 is provided that determines a stepped-up motor torque 206-6 depending on a product of motor torque 206-2 with these parameters 206-3, 206-4.

In the example, a sub-function 206-7 is provided that determines a friction torque 206-8 depending on a difference between the torsion bar torque 202-4 and the stepped-up motor torque 206-6.

In the example, a sub-function 206-9 is provided that determines an unlimited desired friction torque 206-10 depending on the friction torque 206-8.

In one embodiment, it is envisaged that the unlimited desired friction torque 206-10 is determined as a function of a product of the friction torque 206-8 and a predetermined factor 206-11, with which the friction torque is changed.

In one embodiment, it is envisaged that the unlimited desired friction torque 206-10 is determined as a function of a sign for the factor depending on an asymmetry with respect to a reference value 206-12 for the friction torque 206-8. For example, the sign is positive when the friction torque 206-8 is greater than the reference value 206-12. For example, the sign is negative when the friction torque 206-8 is less than the reference value 206-12. For example, the reference value 206-12 is zero.

The factor is 4, for example, if instead of a friction torque 206-8 of 0.25 Nm, an unlimited desired friction torque of 1 Nm is to be set.

In the example, a sub-function 206-13 is provided that determines a desired friction torque 216-14 depending on the unlimited desired friction torque 206-10 and the speed-corrected maximum torque 204-1.

In the example, it is envisaged to limit the unlimited desired friction torque 206-10 to the speed-corrected maximum torque 204-1, and assign the same sign to the desired friction torque 216-14 as the unlimited desired friction torque 206-10 has. It may be contemplated to switch to the maximum value when exceeding a particular steering speed and to limit the unlimited desired friction torque 206-10 to the maximum value.

In one example, the desired friction torque is determined with a sub-function of a plurality of sub-functions that specify respective desired torques. A grand total of these desired torques is converted to desired motor torques by a controller in one example.

In the example, a sub-function 206-15 is provided that determines the desired motor torque 206-1 depending on the desired friction torque 216-14 and the desired torques of the other sub-functions. It may be contemplated for sub-function 206-15 to establish whether the desired motor torque 206-1 is determined based on the desired friction torque 216-14, or based on another torque 216-17. For example, the other torque 216-17 is determined independently of the desired friction torque 216-14 based on the speed-corrected maximum torque 204-1, wherein the speed-corrected maximum torque 204-1 is particularly scaled depending on the steering speed 204-2.

The computing device 104 is configured to perform a method for producing a steering sensation with the steering system 102, as described below with reference to FIG. 3.

The method comprises a step 300.

In step 300, the motor torque 204-2 of the motor 106 and the torsion bar torque 202-4 are determined at the torsion bar 108.

Subsequently, a step 302 is carried out.

In step 302, the stepped-up motor torque 206-6 is determined depending on the motor torque 206-2 and the transmission ratio and the efficiency of the gearing 110.

Subsequently, a step 304 is carried out.

In step 304, the friction torque 206-8 is determined depending on the difference between the stepped-up motor torque 206-6 and the torsion bar torque 202-4.

It may be contemplated for the desired friction torque 206-14 to be determined depending on the predetermined factor 206-11, at which the friction torque 206-8 is changed.

It may be contemplated for the sign of the factor 206-11 to be determined depending on an asymmetry relative to the reference value 206-12 for the friction torque 206-8.

Subsequently, a step 306 is carried out.

In step 306, the desired friction torque 206-14 is determined depending on the friction torque 206-8.

It may be contemplated for the desired friction torque 206-14 to be limited to the maximum value 204-1.

It may be contemplated for the maximum value 204-1 to be determined depending on the vehicle speed 202-2. It may be contemplated for the maximum value 204 to be determined depending on other or additional variables, such as a torsion bar torque, or a lateral acceleration.

Optionally, a step 308 is carried out.

In step 308, the desired friction torque 206-14 is filtered. It may be contemplated for the desired friction torque 206-14 to be filtered with a low-pass filter.

Subsequently, a step 310 is carried out.

In step 310, the desired motor torque 206-1 is determined depending on the desired friction torque 206-14 and the motor torque 206-2.

Subsequently, a step 312 is carried out.

In step 312, the motor 106 is activated to produce the desired motor torque 206-1.

In the example, step 300 is then carried out.

In the example described, there is a reference point for the difference in the torques at the level of the torque at the control element. It may also be contemplated for the reference point to be on the motor torque level. In this case, a stepped-up torque is determined depending on the torque at the control element and the transmission ratio and the efficiency of the gearing, and the friction torque is determined depending on the difference between the motor torque and the stepped-up torque at the control element.

1. A method for producing a steering sensation in a steering system that includes a motor and a control element which are connected to each other via a gearing, wherein the method comprising:
determining a motor torque of the motor; and
determining a torque at the control element;
determining either;
(i) a stepped-up motor torque depending on the motor torque and a transmission ratio and an efficiency of the gearing, and (ii) a friction torque depending on a difference between the stepped-up motor torque and the torque at the control element; or
(i) a stepped-up torque at the control element depending on the torque at the control element and a transmission ratio and an efficiency of the gearing, and (ii) a friction torque is determined depending on a difference between the motor torque and the stepped-up torque at the control element;
determining a desired friction torque depending on the determined friction torque;
determining a desired motor torque depending on the desired friction torque; and
activating the motor is activated to produce the desired motor torque

2. The method according to claim 1, wherein the determining of the desired friction torque includes determining the desired friction torque depending on a predetermined factor, at which the friction torque is changed.

3. The method according to claim 2, wherein the determining of the desired friction torque includes determining a sign for the factor depending on an asymmetry with respect to a reference value for the friction torque.

4. The method according to claim 1, wherein the desired friction torque is limited to a maximum value.

5. The method according to claim 4, wherein the maximum value is determined depending on a vehicle speed.

6. The method according to claim 4, wherein, when a certain steering speed is exceeded, a shift is made to the maximum value.

7. The method according to claim 1, further comprising:
filtering the desired friction torque.

8. The method according to claim 7, wherein the desired friction torque is filtered with a low-pass filter.

9. A device for producing a steering sensation in a steering system which comprises a motor and a control element which are connected to each other via a gearing, the device comprising:
a computing device configured to perform the method according to claim 1 depending on a particular motor torque and a sensed torque at the control element.

10. The device according to claim 9, wherein the device further comprises a torque sensor, configured to sense the torque at the control element.

11. A vehicle comprising:
a steering system comprising the device according to claim 9.

12. The method according to claim 1, wherein the determining of the torque at the control element includes determining a torsion bar torque at a torsion bar.

13. The device according to claim 9, wherein the sensed torque at the control element is a sensed torsion bar torque.

14. The device according to claim 10, wherein the torque sensor is a torsion bar torque sensor configured to sense a torsion bar torque as the sensed torque at the control element.
